(19) United States
(12) Patent Application Publication
(10) Pub. No.: US 2004/0203171 A1
(43) Pub. Date: Oct. 14, 2004

(54) Methods for determining mixing accuracy

(76) Inventors: Bart Degreve, Jumet (BE); Dirk Faict, Assenede (BE); Jean-Pierre Bocquet, Thy-le-Chateau (BE)

Correspondence Address: BAXTER HEALTHCARE CORPORATION, RENAL DIVISION, 1 BAXTER PARKWAY, DF3-3E, DEERFIELD, IL, 60015, US

(21) Appl. No.: 10/412,463

(22) Filed: Apr. 11, 2003

(51) Int. Cl. G01N 21/25

(52) U.S. Cl. 436/171; 356/409

(57) ABSTRACT

Methods for determining mixing accuracy are provided. The present invention includes methods for determining mixing accuracy with respect to mixing devices that are employed to mix a number of solutions, such as dialysis solutions. The mixing accuracy is evaluated based on a spectrophotometric analysis of a surrogate ingredient, such as a colorant, in the mixed solution. The colorant can be added to one of the original solutions prior to mixing.

### BACKGROUND OF THE INVENTION

The present invention generally relates to methods for determining mixing accuracy. More specifically, the present invention relates to methods for determining mixing accuracy with respect to mixing devices used for mixing solutions.

In general, a variety of different devices are known and used to combine and mix solutions. The mixed solutions can be used in a number of different applications including, for example, recreational use, industrial use, medical use and the like.

With respect to medical applications, one or more solutions or ingredients must often be combined to form another solution to be administered to a patient. Combined medical solutions, however, may typically be unstable. Degradation of mixed solutions can occur during the manufacturing process, for example, during sterilization. Likewise, during long-term storage, such products may degrade or suffer reduced efficacy. For example, amino acids and dextrose may be combined to form a parenteral solution for intravenous administration to a patient. If amino acids and dextrose are combined in a single container and stored, coloration takes place, especially during sterilization. Other examples of incompatible solutions include bicarbonate-dextrose, polypeptides-dextrose, bicarbonate-dextrose polymers and polypeptides-dextrose polymers.

In view of the foregoing, in some situations, amino acids and dextrose are sold separately. If a combined amino acid and dextrose solution is prescribed, the amino acid solution and dextrose solution must be combined from two separate containers. The transfer of fluid from one container to another can, however, be time-consuming. Further, fluid transfer is often dangerous due to touch or airborne microbial contamination that may occur during the process.

Therefore, containers have been developed to provide a simplified and less time-consuming procedure for combining at least two solutions. For example, containers having more than one chamber for storing a respective number of solutions prior to mixing are known. The chambers of these containers are segregated from each other, but selective communication is possible through the use of a frangible seal or closure between the chambers which may be opened from outside the container by manipulating the walls of the container. However, often multiple fluids must be mixed. And, often, different combinations of fluids require mixing, or only a single fluid is required for direct infusion to a patient, particularly patients undergoing automated peritoneal dialysis treatment.

In an automated peritoneal dialysis (APD) system, it is often desirable to pump peritoneal dialysis (PD) solutions from different containers in an alternate or simultaneous mode to obtain a mixture of APD solutions for direct delivery to a patient or intermediate delivery to a container for mixing and subsequent delivery to a patient. Further, the volumes of solutions used in APD are larger than volumes of solutions used in, for example, continuous ambulatory peritoneal dialysis (CAPD). Therefore, the ability to directly and simultaneously mix solutions prior to delivery or during delivery of solution to a patient undergoing APD is desirable.

However, even if a device mixes two or more solutions volumetrically, it may be of interest to evaluate mixing accuracy in terms of the chemical ingredients in the original and mixed solutions. In this regard, the mixing accuracy determination can be useful in evaluating the performance of the mixing device. This can be particularly important during medical applications to better ensure that the mixed solutions have the appropriate concentration level of chemical ingredients prior to administration to the patient.

In general, assays are known and used to evaluate the mixing accuracy of a device. However, assays can be problematic as they are often known to be inaccurate with respect to determining the concentration of chemical ingredients. Further, if a device is directed at mixing a broad range of solutions with various ingredients, assays used to measure the concentration of these ingredients (in different solution formulations) might not be available or may require the use of a series of complex and expensive procedures and equipment. In addition, assays must necessarily be validated for the concentration range in which the ingredients are present in the mixed and original solutions, and this range is dependent on the mixing ratio applied by the device.

Other techniques to evaluate mixing accuracy of a mixing device include the use of gravimetric methods. This employs the weights of the individual solutions that are mixed, tracked and converted to volumes by using the density values of the individual solutions. A disadvantage of this method is that the density values are often not available. Also, the precision and accuracy of this method is suspect. In this regard, the density can vary with respect to changes in volume upon mixing and/or temperature.

A need, therefore, exists for improved methods of determining mixing accuracy when mixing solutions, particularly with respect to methods for determining the mixing accuracy of a device that mixes the solutions.

### SUMMARY OF THE INVENTION

The present invention relates, in general, to methods for determining mixing accuracy. In particular, the present invention relates to determining the mixing accuracy of devices that are employed to mix the solutions. The mixing accuracy is evaluated based on a spectrophotometric analysis of a surrogate ingredient, such as a colorant, in the mixed solution. The colorant can be added to one of the original solutions prior to mixing. In this regard, the mixing accuracy determination is independent of the composition and the temperature of the original solutions at the time of mixing.

As applied, a universal spectrophotometrical method can be carried out to determine the mixing accuracy for a broad range of solutions and a broad range of mixing ratios. Further, the present invention can determine the mixing accuracy with high accuracy, such as determining a deviation from the target mixing ratio to as low as about 1% or less. In an embodiment, the colorant includes SUNSET YELLOW (SY).

The present invention can be applied to a variety of different types of mixing devices. In an embodiment, the present invention provides a mixing accuracy for mixing devices and systems used during dialysis. For example, the mixing devices and systems can be used to make ready-to-use dialysis solutions.

In an embodiment, the present invention provides a method for determining a mixing accuracy of a device that mixes a plurality of solutions in a certain mixing ratio to form a mixed solution. The method at least includes determining spectrophotometrically a concentration of a colorant in the mixed solution.

In yet another embodiment, the present invention provides a method for determining a mixing accuracy of a mixing device capable of mixing a plurality of solutions at a target mixing ratio, thus forming a mixed solution. The method includes preparing a series of standard solutions that include a colorant wherein the standard solutions are prepared in volumetric ratios selected around the target mixing ratio. The standard solutions are spectrophotometrically analyzed to provide a standard absorbance value, such as at wavelength specific to the applied colorant, associated with the standard solutions. Based on the spectrophotometric analysis, a calibration curve is prepared corresponding to the absorbance value and the colorant concentration associated with the standard solutions. A deviation from the target mixing ratio during mixing can be determined using a calibration equation derived from the calibration curve to calculate a concentration of the colorant in the mixed solution.

In still yet another embodiment, a method for evaluating a mixing accuracy of a mixing device capable of mixing a plurality of solutions at a target mixing ratio thereby forming a dialysis solution is provided. The method includes preparing a plurality of standard solutions wherein the standard solutions include a colorant at a respective standard colorant concentration. The concentration of the colorant associated with the standard solutions is selectively spaced around a target colorant concentration based on the target mixing ratio. The standard solutions are analyzed spectrophotometrically, thus providing a standard absorbance value associated with the standard solutions. A calibration curve is developed based on the standard absorbance value and the concentration of the colorant associated with the respective standard solutions.

In an embodiment, the colorant concentration in the mixed solution is expressed relative to a pre-mixed colorant concentration in at least one of the solutions prior to mixing such that the colorant concentration can be calculated without determining an exact or actual concentration of the pre-mixed colorant concentration.

The mixing device is operated to form the mixed solution derived from the plurality of solutions wherein at least one of the solutions includes the colorant. The mixed solution is spectrophotometrically measured to provide an absorbance value from which the colorant concentration of the mixed solution can be calculated based on a calibration equation derived from the calibration curve. The calculated colorant concentration is compared to an expected colorant concentration in the mixed solution based on the target mixing ratio thereby providing a deviation from the target mixing ratio.

An advantage of the present invention is to provide improved methods for determining the mixing accuracy of mixing devices.

A further advantage of the present invention is to provide improved methods for evaluating the mixing accuracy of mixing devices used to form dialysis solutions.

A still further advantage of the present invention is to provide improved methods for determining mixing accuracy based on a spectrophotometric analysis.

Yet another advantage of the present invention is to provide improved methods for determining and monitoring mixing accuracy of mixing devices and systems thereof.

Additional features and advantages of the present invention are described in, and will be apparent from, the following Detailed Description of the Invention and the figures.

### BRIEF DESCRIPTION OF THE FIGURES

FIG. 1 illustrates a graphical representation of a calibration curve pursuant to an embodiment of the present invention as described in EXAMPLE TWO.

### DETAILED DESCRIPTION OF THE INVENTION

The present invention relates to methods for determining mixing accuracy. In particular, the present invention relates to determining or evaluating the mixing accuracy with respect to devices that mix solutions in a specific target or desired volumetric mixing ratio to form a mixed solution. The mixing accuracy determination of the present invention is highly accurate. In an embodiment, the mixing accuracy determination can be used to evaluate a deviation or variation from a target mixing ratio that is as low as about 1% or less.

In general, the mixing accuracy is evaluated based on a spectrophotometric analysis of a surrogate ingredient, such as a colorant, in the mixed solution. The colorant can be added to at least one of the original solutions prior to mixing. The amount of colorant in both the original and mixed solutions can be detected spectrophotometrically. In this regard, the mixing accuracy determination can be applied to a broad range of solutions and a broad range of mixing ratios.

In an embodiment, the mixing accuracy is evaluated for a mixing device that mixes two solutions to form a single mixed solution. As applied, the colorant or other suitable surrogate is added to one of the original two solutions. Based on the spectrophotometric analysis of the colorant in the mixed solution, the mixing accuracy can be determined as described in detail below. However, it should be appreciated that the present invention can be applied to a mixing device or devices that can mix two or more solutions and thus capable of forming one or more mixed solutions. In this regard, the mixing accuracy determination can be based on the spectrophotometric analysis of the amounts of one or more colorants that have been added to the original solutions prior to mixing wherein the colorants each have a unique wavelength spectrum.

A variety of different types of colorants, suitable other surrogate ingredients and mixtures thereof can be employed to determine the mixing accuracy. In an embodiment, the colorant includes SUNSET YELLOW. Examples of other types of colorants include METHYLENE BLUE or ferric chloride hydrate (FeCl₃.6H₂O). Any suitable amount of the colorant can be used. It may be necessary to adjust the amount of colorant to prevent precipitation thereof in solution depending on the type of colorant that is used. In addition, it may be necessary to adjust the solution pH to prevent same.

As previously discussed, the present invention provides a method to evaluate the mixing accuracy of a mixing device based on a spectrophotometric analysis of the concentration of a colorant or the like in the mixed solution as compared to the colorant concentration in one or more of the original or non-mixed solutions. In this regard, the relationship between the concentration of the colorant in the mixed solution and in the original solutions can be defined as follows:

eC_{M}=R*C_{A}

where eC_{M} is the expected concentration of the colorant (C) in the mixed solution (M), R is the target mixing ratio, and C_{A} is the concentration of the colorant in one of the original solutions (A). The target ratio R represents a relative volumetric amount of solution A in the mixed solution M.

In an embodiment, the mixing accuracy can be determined by a comparison of the expected concentration of the colorant in the mixed solution (eC_{M}) and the calculated concentration of the colorant in the mixed solution (cC_{M}) based on a percent error calculation. The calculated concentration can be an actual or exact concentration or a relative concentration, for example, as expressed relative to C_{A} described below in greater detail. The percent error, in an embodiment, can be calculated as follows:

$$\begin{matrix}Percent Error ( \% ) = ( ( {cC}_{M} - e {C}_{M} ) / e {C}_{M} ) * 100 \\ = ( {cC}_{M} / e {C}_{M} - 1 ) * 100 \\ = ( {cC}_{M} / ( R * {C}_{A} ) - 1 ) * 100\end{matrix}$$

where the percent error is negative in value if cC_{M}<(R*C_{A}) and where the percent error is positive in value if cC_{M}>(R*C_{A}).

It should be appreciated that it is not required, nor is it necessary, to know the exact or actual concentration of the colorant in the original solution (e.g., C_{A}). In this regard, if C_{A} is set to 1, for example, all of the other colorant concentrations (e.g., cC_{M and eC}_{M}) can be expressed relative to C_{A}. Thus, the percent error can be calculated once the relative or actual concentration of the colorant in the mixed solution (cC_{M}) is obtained.

To this end, a series of standard solutions can be prepared. The standard solutions represent two or more solutions with a colorant concentration regularly spaced around the target concentration in the mixed solution (eC_{M}) associated with the specific mixing ratio (R) of the device. Once prepared, an absorbance value is determined for each standard solution via spectrophotometric analysis in any known and suitable manner. For example, any suitable, known and commercially-available spectrophotometer can be employed to measure the absorbance associated with the concentration of the colorant in the standard solutions. In this regard, the absorbance measurement is based on a wavelength spectrum specific to the colorant of choice. In an embodiment, the absorbance at 483 nanometers (nm) is measured based on the concentration of the colorant SUNSET YELLOW in solution. In general, the spectrophotometric measurements should be performed at the same or substantially the same temperature since the colorant concentration may vary with temperature due to temperature-dependent changes in solution density.

Once the absorbance values for the standard solutions are determined, these values can be plotted against the corresponding colorant concentration associated with the respective standard solution. The plot can be used to generate an equation based on a best-fit calibration curve that represents the relationship between the absorbance and the colorant concentration. The relationship may be linear, polynomial or the like.

It should be appreciated that the calibration curve may need to be validated. In general, recovery values should be between 99.5% and 100.5%. The recovery value is defined as follows:

recovery value=(cC_{Sx}/eC_{Sx})*100

where cC_{Sx} is the calculated colorant concentration in the standard Sₓ (starting with the averaged measured absorbance value for the particular standard Sₓ, followed by conversion to the colorant concentration using the calibration curve); and eC_{Sx} is the expected colorant concentration in the standard S_{X}.

With the calibration equation, the relative or actual colorant concentration in the mixed solution C_{M} can be calculated. In this regard, the absorbance value of the mixed solution based on the concentration of the colorant is determined via spectrophotometric analysis and averaged, if applicable. Based on this value, the amount of colorant in the mixed solution is calculated using the calibration equation as discussed above. Then, the percent error can be calculated based on the percent error equation as previously discussed.

The present invention can be applied to determine the mixing accuracy of a variety of suitable and different mixing devices including a variety of suitable and different types of pumps, such as diaphragm pumps, vacuum-assisted pumps, positive-displacement pumps, peristaltic pumps and other pumps suitable for mixings solutions in volumetric proportion. In an embodiment, the method is particularly useful for the evaluation of the mixing accuracy of a device that prepares solutions for dialysis by mixing two or more concentrated solutions to yield a ready-to-use dialysis solution. Alternatively, the device could be used to mix conventional dialysis solutions so as to provide a new dialysis solution with a specific formulation. Examples of such mixing devices and systems used to mix solutions during dialysis treatment include the mixing devices and systems disclosed in U.S. Pat. No. 5,925,011, entitled “SYSTEM AND METHOD FOR PROVIDING STERILE FLUIDS FOR ADMIXED SOLUTIONS IN AUTOMATED PERITONEAL DIALYSIS, the disclosure of which is incorporated herein by reference. It should be appreciated that the present invention is not only applicable to devices and systems for the preparation of dialysis solutions, or dialysis machines, but also to any other device and system that can mix two or more solutions.

With respect to dialysis therapy, the present invention can be used to determine the mixing accuracy of a device used in a variety of different dialysis therapies to treat kidney failure. Dialysis therapy as the term or like terms are used throughout the text is meant to include and encompass any and all forms of therapies to remove waste, toxins and excess water from the patient. The hemo-therapies, such as hemodialysis, hemofiltration and hemodiafiltration, include both intermittent therapies and continuous therapies used for continuous renal replacement therapy (CRRT). The continuous therapies include, for example, slow continuous ultrafiltration (SCUF), continuous venovenous hemofiltration (CVVH), continuous venovenous hemodialysis (CVVHD), continuous venovenous hemodiafiltration (CVVHDF), continuous arteriovenous hemofiltration (CAVH), continuous arteriovenous hemodialysis (CAVHD), continuous arteriovenous hemodiafiltration (CAVHDF), continuous ultrafiltration periodic intermittent hemodialysis or the like. The present invention can also be used during peritoneal dialysis including, for example, continuous ambulatory peritoneal dialysis, automated peritoneal dialysis, continuous flow peritoneal dialysis and the like. However, it should be appreciated that the present invention can be utilized with a variety of different applications, physiologic and non-physiologic, in addition to dialysis.

### EXAMPLES

The following examples are provided to illustrate, without limitation, the method for determining mixing accuracy according to an embodiment of the present invention. EXAMPLE ONE describes, in general, how the mixing accuracy method of the present invention can be carried out with respect to any suitable mixing device and application thereof. EXAMPLE TWO describes how the mixing accuracy method of the present invention can be applied to a mixing device that is employed to mix solutions in order to form a ready-to-use dialysis solution.

### Example One

A mixing device is adapted to mix solutions A and B at a target mixing ratio. One or more mixed solution samples M can be prepared using the mixing device. The colorant SUNSET YELLOW is added to Solution A, but not solution B, in a pre-determined concentration. This can accomplished by taking a small volume out of the container in which solution A is stored, and replacing it with the same volume of a concentrated SUNSET YELLOW stock solution. It is necessary that the compatibility of SUNSET YELLOW with solution A and mixed solution M, as well as the stability of SUNSET YELLOW in solution A and mixed solution M, within the timeframe relevant for the experimental procedure is confirmed in advance.

Based on the target mixing ratio, a series of standard solutions are prepared. The standard solutions include a mixture of solution A that includes the colorant SUNSET YELLOW at the pre-determined concentration and solution B. The amount of colorant in the standard solutions is regularly spaced around the target concentration associated with the target mixing ratio. The target concentration of SUNSET YELLOW in the mixed solution is R*CY_{A} as previously discussed. In this regard, the standard solutions are prepared by mixing the original solutions in volumetric ratios that are selectively and regularly spaced around the target mixing ratio. The standards are prepared by diluting solution A that includes the colorant with different amounts of solution B in order to take into account a possible matrix effect. An example of the SUNSET YELLOW standard solutions is provided below (for a mixing ratio R of 0.75):

Standard Solution One (S1): 65 ml solution A+35 ml solution B

Standard Solution Two (S2): 70 ml solution A+30 ml solution B

Standard Solution Three (S3): 75 ml solution A+25 ml solution B

Standard Solution Four (S4): 80 ml solution A+20 ml solution B

Standard Solution Five (S5): 85 ml solution A+15 ml solution B

Absorbance at 483 nm is measured for each of the standard solutions (Sx) and the mixed solution sample(s) M using a spectrophotometer. To ensure that both the standards and the mixed solution sample(s) are at the same temperature, the cuvette chambers associated with the spectrophotometer can be temperature-equilibrated. This can be conducted in any suitable manner, such as with cell holders for the solutions in which water can be circulated at a specified temperature and in a non-contact manner, for example by circulating water from a water-circulating device connected to a water bath at 21° C. An averaged absorbance value for each analyzed sample should be obtained based on at least two independent absorbance measurements. Distilled water or any other suitable solution can be used as a blank solution during the spectrophotometric determinations.

Based on the spectrophotometric analysis of the standard solutions, a calibration curve can be prepared by plotting the averaged absorbance values with respect to the corresponding colorant concentration associated with the standard solutions. This should be validated as discussed above. As a result, a best-fit calibration equation can be generated based on the calibration plot. This equation can then be used to calculate the concentration, relative or exact, of the colorant in the mixed solution. In this regard, the mixing accuracy can be determined based on the percent error calculation as previously discussed.

It should be appreciated that the present invention is not limited to the mixing accuracy determination of a mixing device that mixes two solutions but can evaluate the mixing accuracy of a device that mixes more than two solutions in any particular mixing ratio. In an embodiment, the mixing accuracy can be determined by adding a colorant to any one of the solutions prior to mixing. Alternatively, two or more colorants with a different wavelength spectrum in an embodiment can be used simultaneously. For example, solution A may include a first colorant characterized by a first wavelength, solution B may include a second colorant characterized by a second wavelength and solution C may not include a colorant.

### Example Two

As previously discussed, this example is provided to illustrate the mixing accuracy method of the present invention as applied to a mixing device that mixes solutions to form a ready-to-use dialysis solution pursuant to an embodiment of the present invention. In particular, the mixing accuracy is determined based on the performance of the mixing device with respect to mixing two solutions, namely a bicarbonate-containing solution and a glucose-containing solution hereinafter referred to as a bicarbonate solution and a glucose solution, respectively. In this example, the target mixing ratio is a 1:1 volumetric ratio of bicarbonate solution to glucose solution in the mixed solution (i.e., R=0.5). The test solutions are mixed to form a ready-to-use dialysis solution based on an automated peritoneal dialysis system.

In general, the bicarbonate solution and glucose solution were prepared and stored in separate solution bags. The bicarbonate solution contained about 16 mg/l of SUNSET YELLOW.

A number of standard solutions were prepared that included a mixture of the bicarbonate solution containing SUNSET YELLOW and the glucose solution. The following standard solutions were prepared:

Standard Solution One (S1): 30 ml bicarbonate solution+70 ml glucose solution;

Standard Solution Two (S2): 40 ml bicarbonate solution+60 ml glucose solution;

Standard Solution Three (S3): 50 ml bicarbonate solution+50 ml glucose solution;

Standard Solution Four (S4): 60 ml bicarbonate solution+40 ml glucose solution;

Standard Solution Five (S5): 70 ml bicarbonate solution+30 ml glucose solution.

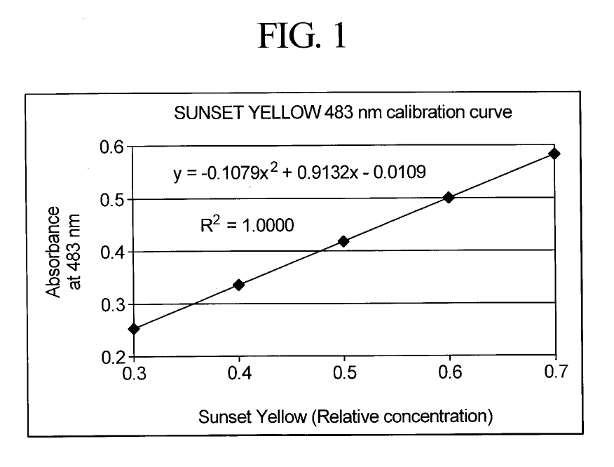

Each of the standard solutions was analyzed spectrophotometrically to obtain an absorbance value at 483 nm. A polynomial calibration curve was constructed, and the relative concentration of SUNSET YELLOW in the Standards was calculated using the calculated calibration equation. The percentage recovery values were obtained to determine whether the calibration curve was valid. Calibration data obtained are shown below in TABLE I (see also FIG. 1):

TABLE 1

| | Expected | | Calculated | % Recovery |
|---|---|---|---|---|
| | relative SY | | relative SY | value |
| | concentration | Absorbance | concentration | (cCY_{Sx}/ |
| Standards | (eCY_{Sx}) | at 430 nm | (cCY_{Sx}) | (eCY_{Sx})*100 |
| S1 | 0.3000 | 0.2538 | 0.3005 | 100.18 |
| S2 | 0.4000 | 0.3360 | 0.3987 | 99.66 |
| S3 | 0.5000 | 0.4189 | 0.5002 | 100.04 |
| S4 | 0.6000 | 0.4989 | 0.6009 | 100.15 |
| S5 | 0.7000 | 0.5750 | 0.6994 | 99.91 |

Polynomial calibration equation: y = −0.1079 x² + 0.9132 x − 0.0109
R² = 1.0000
The % Recovery values are all within the 99.5-100.5% range.

Seven mixed solution samples were obtained with a 1:1 volumetric target ratio of bicarbonate solution to glucose solution in the mixed solution. The test solutions were mixed to form a ready-to-use dialysis solution based on an automated peritoneal dialysis system. The absorbance values at 483 nm were obtained, after which the relative SUNSET YELLOW concentrations were calculated. The final results were expressed as percent error as discussed above and shown below in TABLE 2 as follows:

TABLE 2

| | | Calculated relative | |
|---|---|---|---|
| | Absorbance | SY concentration | % Error |
| Samples | at 483 nm | (cCY_{M}) | ((cCY_{M}/0.5) − 1)*100 |
| A | 0.4182 | 0.4993 | −0.13% |
| B | 0.4183 | 0.4995 | −0.11% |
| C | 0.4184 | 0.4996 | −0.08% |
| D | 0.4186 | 0.4998 | −0.03% |
| E | 0.4179 | 0.4990 | −0.20% |
| F | 0.4181 | 0.4992 | −0.16% |
| G | 0.4189 | 0.5002 | +0.04% |

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention is claimed as follows:

1. A method for determining a mixing accuracy of a device that mixes a plurality of solutions in a target mixing ratio thereby forming a mixed solution, the method comprising determining spectrophotometrically a relative concentration of a colorant in the mixed solution.

2. The method of claim 1 wherein the colorant is added to one or more of the original solutions at a target concentration.

3. The method of claim 2 wherein a plurality of standard solutions are prepared by mixing the solutions at respective standard mixing ratios regularly spaced around the target mixing ratio.

4. The method of claim 3 wherein an absorbance value at a wavelength specific to the colorant is measured spectrophotometrically with respect to at least a portion of the standard solutions.

5. The method of claim 4 wherein a calibration curve is prepared based on the measured absorbance values.

6. The method of claim 5 wherein the relative concentration of the colorant in the mixed solution is calculated based on an equation derived from the calibration curve.

7. The method of claim 6 wherein a deviation from the target mixing ratio is calculated based on the calculated relative concentration of the colorant compared to an expected relative concentration of the colorant.

8. The method of claim 7 wherein the deviation from the target mixing ratio can be detected to about 1% or less.

9. The method of claim 1 wherein the colorant comprises SUNSET YELLOW.

10. The method of claim 1 wherein the device comprises a medical device.

11. The method of claim 10 wherein the medical device comprises a mixing device for preparing dialysis solutions including ready-to-use dialysis solutions.

12. The method of claim 10 wherein the device comprises a dialysis machine including a mixing device for preparing dialysis solutions including ready-to-use dialysis solutions.

13. A method for determining a mixing accuracy of a mixing device capable of mixing a plurality of solutions at a target mixing ratio thereby forming a mixed solution, the method comprising the steps of:
preparing two or more standard solutions that include a colorant in a respective volumetric ratio selected around the target mixing ratio;
spectrophotometrically analyzing a standard absorbance value associated with the standard solutions;
preparing a calibration curve based on the standard absorbance value and a standard concentration of the colorant associated with the standard solutions; and
determining a deviation from the target mixing ratio during mixing using a calibration equation derived from the calibration curve to calculate a concentration of the colorant in the mixed solution.

14. The method of claim 13 wherein the deviation from the target mixing ratio can be detected to about 1% or less.

15. The method of claim 13 wherein the colorant comprises SUNSET YELLOW.

16. The method of claim 13 wherein the device comprises a medical device.

17. The method of claim 13 wherein the medical device comprises a mixing device for preparing dialysis solutions including ready-to-use dialysis solutions.

18. The method of claim 13 wherein the device comprises a dialysis machine including a mixing device for preparing dialysis solutions including ready-to-use dialysis solutions.

19. The method of claim 13 wherein the calculated colorant concentration in the mixed solution is an actual concentration.

20. The method of claim 13 wherein the calculated colorant concentration in the mixed solution is expressed relative to a colorant concentration in at least one of the solutions prior to mixing.

21. The method of claim 13 wherein the solutions are mixed to form the mixed solution and subsequently the deviation from the target mixing ratio is determined.

22. A method for evaluating a mixing accuracy of a mixing device capable of mixing a plurality of solutions at a target mixing ratio thereby forming a dialysis solution, the method comprising the steps of:
preparing a plurality of standard solutions wherein each of the standard solutions includes a colorant at a standard colorant concentration selectively placed around a target colorant concentration based on the target mixing ratio;
spectrophotometrically measuring a standard absorbance value associated with the standard solutions;
developing a calibration curve based on the standard absorbance value and the standard colorant concentration associated with the respective standard solutions;
operating the mixing device to form a mixed solution derived from the plurality of solutions wherein at least one of the solutions includes the colorant in an amount sufficient to produce the target colorant concentration in the mixed solution based on the target mixing ratio;
spectrophotometrically measuring an absorbance value associated with the mixed solution;
calculating the colorant concentration in the mixed solution based on a calibration equation derived from the calibration curve; and
comparing the colorant concentration to an expected colorant concentration in the mixed solution based on the target mixing ratio thereby determining a deviation from the target mixing ratio.

23. The method of claim 22 wherein the mixing device is used during dialysis therapy.

24. The method of claim 22 wherein one or more colorants are used.

25. The method of claim 22 wherein the colorants at least include SUNSET YELLOW.

26. The method of claim 22 wherein the deviation from the target mixing ratio can be detected to about 1% or less.

27. The method of claim 22 wherein the colorant concentration in the mixed solution is expressed relative to a pre-mixed colorant concentration in at least one of the solutions prior to mixing such that the colorant concentration can be calculated without determining an exact concentration of the pre-mixed colorant concentration.

28. The method of claim 22 wherein the absorbance value corresponds to a wavelength specific to the colorant in solution.
